(19) United States
(12) Patent Application Publication
(10) Pub. No.: US 2006/0273103 A1
(43) Pub. Date: Dec. 7, 2006

(54) Vending machine having rotating fetch device

(76) Inventor: Yung Hsing Lin, Taichung (TW)

Correspondence Address: Yung Hsing Lin, P.O. Box 63-298, Taichung, 40699, TW

(21) Appl. No.: 11/144,473

(22) Filed: Jun. 6, 2005

(51) Int. Cl. G07F 11/00

(52) U.S. Cl. 221/92

(57) ABSTRACT

A vending machine includes a receptacle having a delivery chute, one or more magazines disposed in the receptacle for receiving goods to be sold, and an actuating device for actuating a fetching device to fetch the selected goods from the magazines, and to deliver the goods toward the delivery chute of the receptacle, for allowing users to obtain the goods via the delivery chute of the receptacle. A rotatable frame is disposed in the receptacle to support the magazines. A rotating device may rotate the fetching device, and three moving devices may move the fetching device along three directions. The fetching device includes a vacuuming member for moving the goods from the magazine toward the delivery chute.

### BACKGROUND OF THE INVENTION

1. Field of the Invention

The present invention relates to a vending machine, and more particularly to a vending machine having a movable and rotatable fetching device for fetching and delivering the selected goods to the delivery chute.

2. Description of the Prior Art

Various kinds of typical vending machines have been developed and comprise a number of coin chutes for receiving the coins, and a number of magazines for receiving and storing various kinds of goods to be sold, and a number of buttons to be depressed or actuated by the users, in order to determine the required goods to be purchased.

For example, U.S. Pat. No. 462,024 to Wood discloses one of the typical vending machines also comprising a number of magazines for receiving and storing various kinds of goods to be sold, and a number of coin chutes for receiving the coins, and a number of buttons to be depressed or actuated by the users, in order to select the required goods that may be dropped and obtained by the users from the delivery chutes.

U.S. Pat. No. 1,459,504 to Grover et al. discloses another typical vending machine operatable upon the deposition of a proper coin for the delivery of a suitable commodity, and comprising several magazines for receiving and storing various kinds of goods to be sold, the operating mechanism associated with each magazine is carried by a framework which is movable as a unit from the machine, independently of the other mechanism.

In these typical vending machines, the selected goods will be automatically dropped into the delivery chutes after the proper coins have been deposited into the vending machine. However, the users may not know or may not see how the selected goods are selected and dropped into the delivery chutes.

The present invention has arisen to mitigate and/or obviate the afore-described disadvantages of the conventional vending machines.

### SUMMARY OF THE INVENTION

The primary objective of the present invention is to provide a vending machine including a movable and rotatable fetching device for fetching and delivering the selected goods to the delivery chute, and for allowing the users to watch and to see how the selected goods are selected and dropped into the delivery chutes.

In accordance with one aspect of the invention, there is provided a vending machine comprising a receptacle including a delivery chute, at least one magazine disposed in the outer receptacle for receiving goods to be sold, a fetching device, and an actuating device for actuating the fetching device to fetch the selected goods from the magazine, and to deliver the goods toward the delivery chute of the receptacle, for allowing users to obtain the goods via the delivery chute of the receptacle.

The receptacle includes a frame disposed therein, to support the magazine on the frame. The receptacle includes a motor disposed therein and having a spindle coupled to the frame, for rotating the frame relative to the receptacle. The frame includes a number of slots formed therein, and the magazine includes two flaps selectively engaged in the slots of the frame.

The actuating device includes a motor having a spindle attached to the fetching device, for rotating the fetching device relative to the receptacle and the magazine. The actuating device includes a horizontal moving device having the motor and the fetching device disposed thereon, for moving the motor and the fetching device forwardly and rearwardly relative to the receptacle and the magazine.

The horizontal moving device includes a lazy bone device having the motor and the fetching device disposed on one end thereof, and expandable for moving the motor and the fetching device forwardly and rearwardly relative to the receptacle and the magazine.

The horizontal moving device includes a block, a bolt rotatably attached to the block, a slide threaded with the bolt and coupled to the lazy bone device, and a motor attached to the block and coupled to the bolt, for rotating the bolt to move the slide along the bolt by the motor.

The lazy bone device includes at least one pin extended therefrom, a guide member attached thereto and having a groove formed therein for slidably receiving the pin, and for guiding the guide member and the lazy bone device to move forwardly and rearwardly relative to the receptacle and the magazine.

The actuating device includes a vertical moving device having the horizontal moving device disposed thereon, for moving the horizontal moving device and the fetching device up and down relative to the receptacle and the magazine. The vertical moving device includes a lazy bone device having a table provided on top thereof for supporting the horizontal moving device thereon, a screw coupled to a motor and threaded with the lazy bone device, to selectively expand and retract the lazy bone device.

The actuating device includes a lateral moving device having a carrier to support the vertical moving device thereon. The lateral moving device includes a bolt rotatably supported between two stops, the carrier includes a screw hole formed therein for threading with the bolt, and a motor attached to one of the stops and coupled to the bolt, for rotating the bolt to move the carrier along the bolt. The lateral moving device includes a rail, the stops are attached on the rail, and the carrier is slidably engaged on the rail.

The fetching device includes a vacuuming member coupled to a vacuum source, for engaging with and for moving the goods from the magazine toward the delivery chute of the receptacle. The fetching device includes a hose coupled to the vacuuming member, and a rotating element coupled to the hose, for rotating and directing the vacuuming member toward the goods.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a vending machine in accordance with the present invention;

FIG. 2 is a perspective view of the vending machine, similar to FIG. 1, in which an outer container has been removed for showing the inner structure of the vending machine;

FIGS. 3, 4, 5 are partial cross sectional views of the vending machine, taken along lines 3-3, 4-4, and 5-5 of FIG. 1 respectively;

FIG. 6 is a partial cross sectional view similar to FIG. 3, illustrating the operation of the vending machine;

FIG. 7 is an enlarged partial upper plan view, illustrating the operation of the vending machine;

FIGS. 8, 9 are perspective views similar to FIGS. 1 and 2 respectively, illustrating the other arrangement of the vending machine;

FIG. 10 is a partial exploded view illustrating a fetching device of the vending machine;

FIGS. 11, 12 are perspective views illustrating the operation of the fetching device of the vending machine;

FIGS. 13, 14, 15 are partial cross sectional views similar to FIGS. 3 and 6, illustrating the operation of the vending machine;

FIG. 16 is an enlarged partial cross sectional view illustrating the fetching device of the vending machine;

FIGS. 17, 18 are partial cross sectional views similar to FIG. 4, illustrating the operation of the vending machine; and

FIG. 19 is an enlarged partial cross sectional view similar to FIGS. 13-15, illustrating the operation of the vending machine.

### DETAILED DESCRIPTION OF THE PREFERRED EMBODIMENT

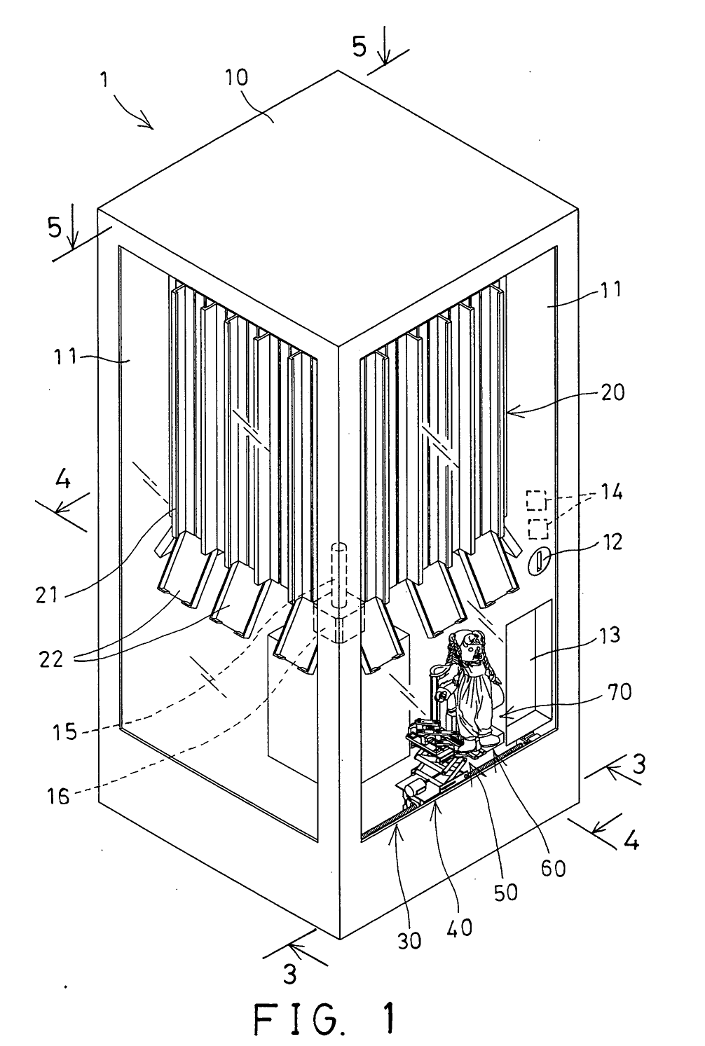

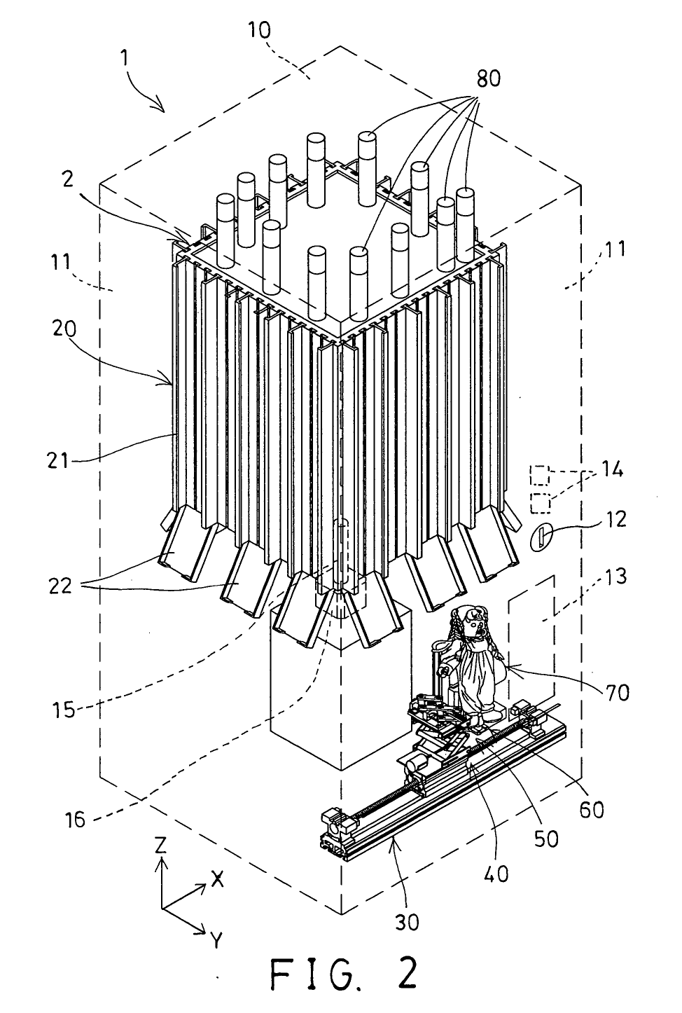

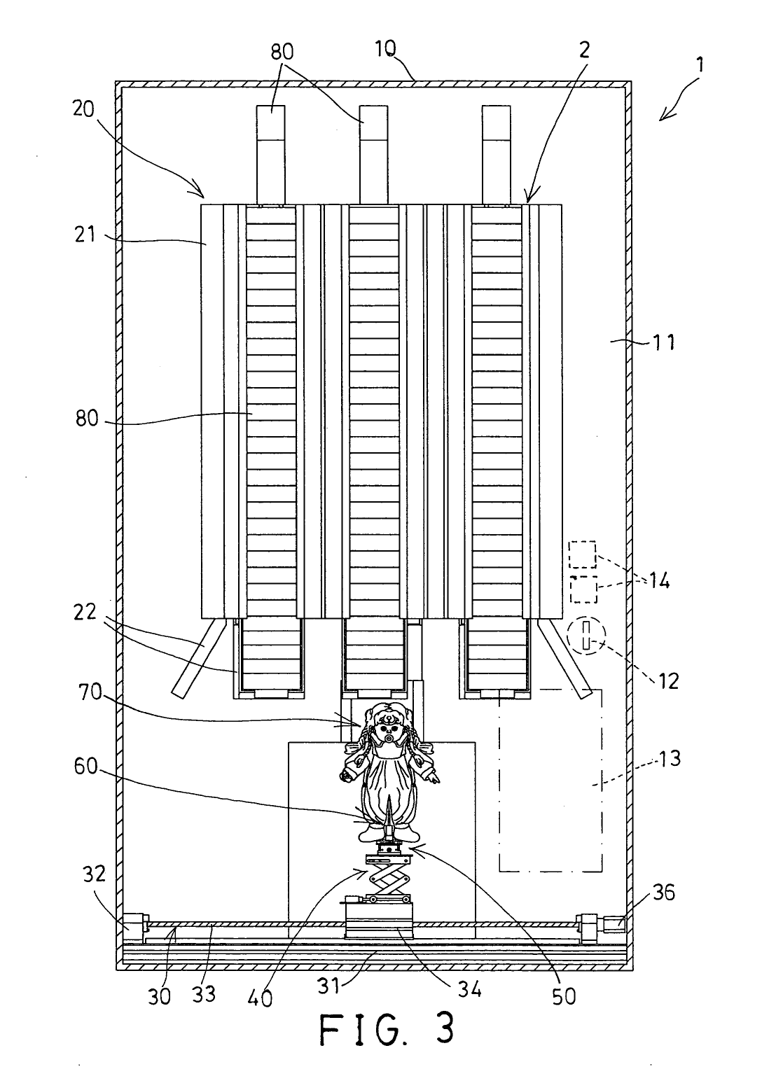

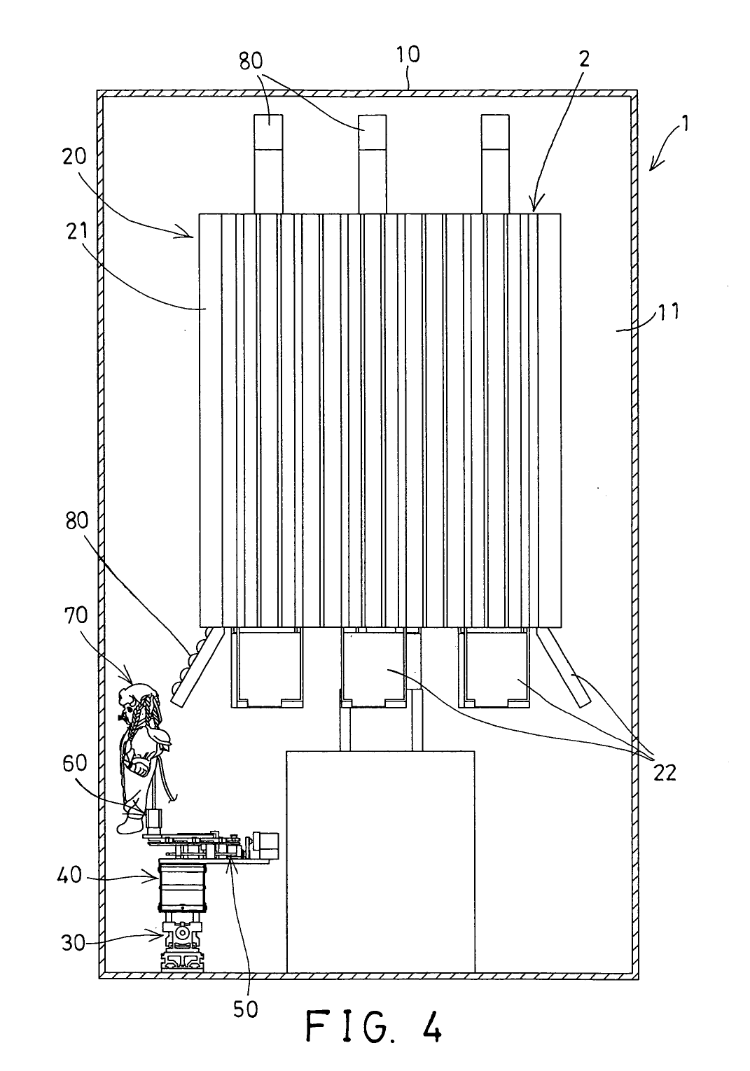

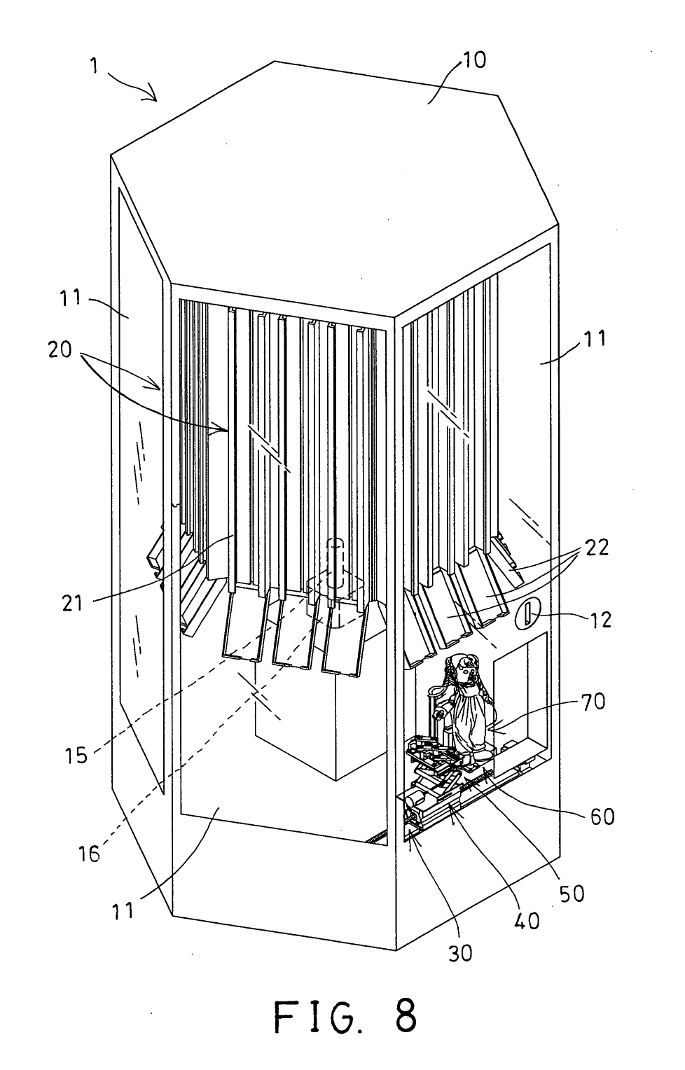

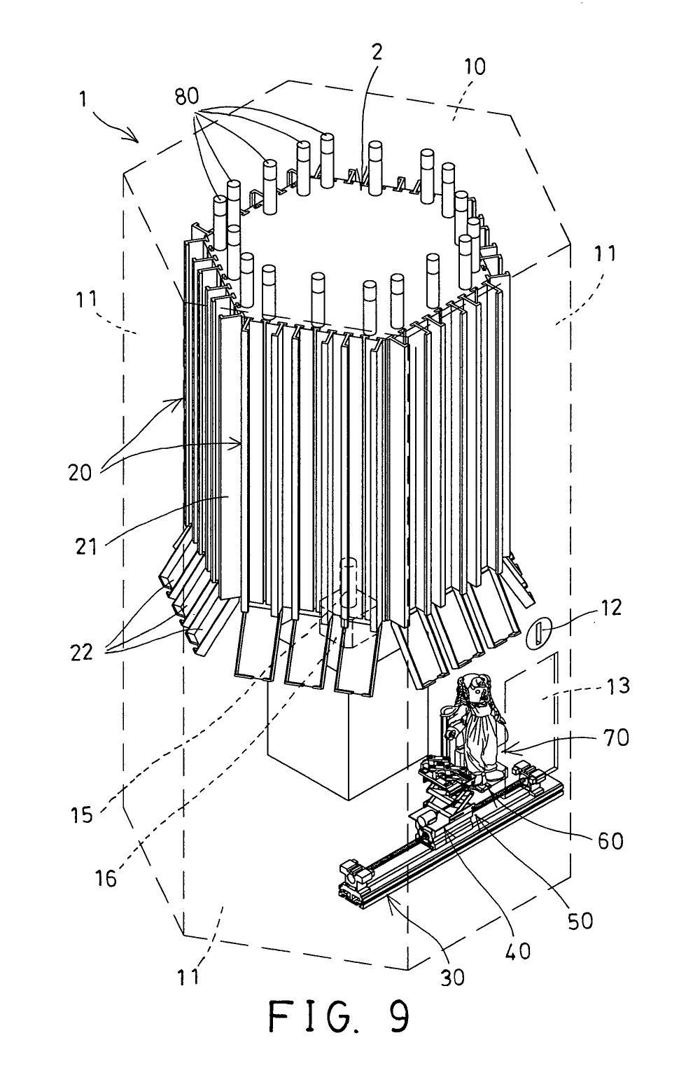

Referring to the drawings, and initially to FIGS. 1-5, a vending machine 1 in accordance with the present invention comprises an outer receptacle 10 including one or more, such as four transparent outer windows 11 (FIGS. 1 and 2), or six or more transparent outer windows 11 (FIGS. 8 and 9) provided thereon, for allowing the users to view or to see the goods suspended or supported within the outer receptacle 10, and including one or more typical chutes 12 for receiving coins or paper money or the like from the users.

The outer receptacle 10 also includes an outlet port or delivery chute 13, for receiving the goods, such as cosmetic materials, and for allowing the users to fetch or to obtain the selected or the sold goods, and also includes a number of buttons 14 for being depressed or actuated by the users, in order to choose or to selected the required goods. The structures of the coin chutes 12, the delivery chute 13, and the buttons 14 are not related to the present invention and will not be described in further details.

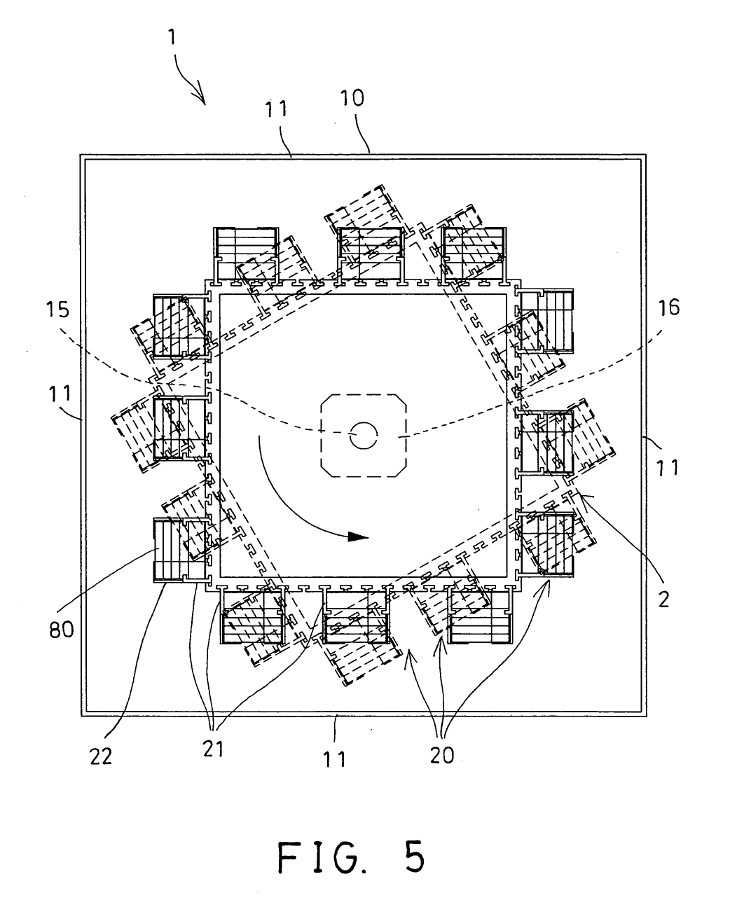

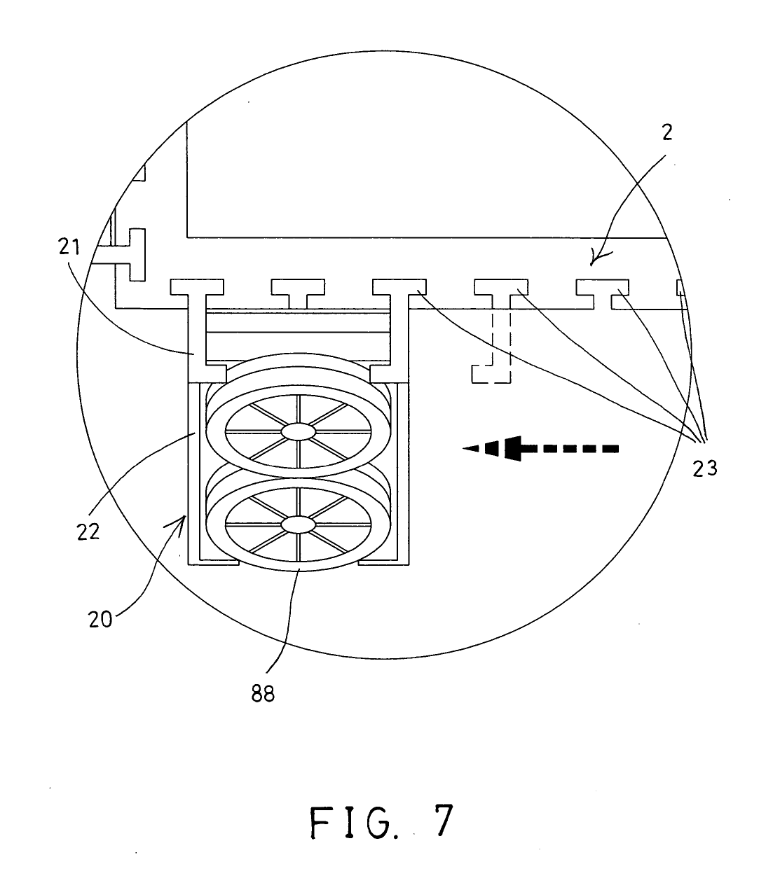

A frame 2 is disposed on or attached to a spindle 15 of a motor 16 which is disposed on bottom of the outer receptacle 10, for allowing the frame 2 to be rotated relative to the outer receptacle 10, about or around the spindle 15, by the motor 16. The frame 2 includes a number of magazine 20 disposed thereon or attached thereto, and each formed or defined by two side flaps 21, best shown in FIGS. 5 and 7, and each having a ramp 22 formed or provided in the lower portion thereof, for receiving the goods 80 to be sold.

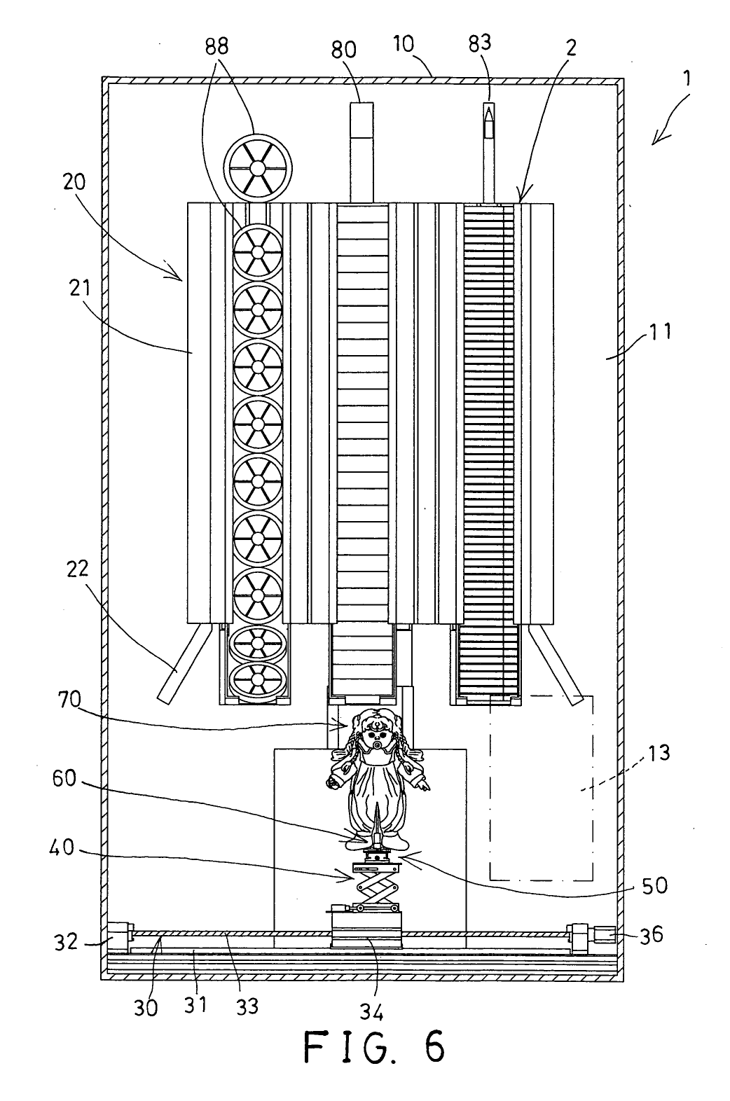

As best shown in FIG. 7, the frame 2 includes a number of longitudinal slots 23 formed therein, for adjustably or selectively receiving the flaps 21, in order to adjust the distance between the flaps 21 of the magazine 20, and so as to receive or to accommodate the other goods 83, 88 of different width (FIGS. 6, 7), or the like. As shown in FIGS. 2-4, 6 and 9, one or more of the goods 80, 83, 88 may be disposed on the frame 2, and preferably arranged on top of the corresponding magazines 20, for showing or displaying the goods 80, 83, 88 for sale.

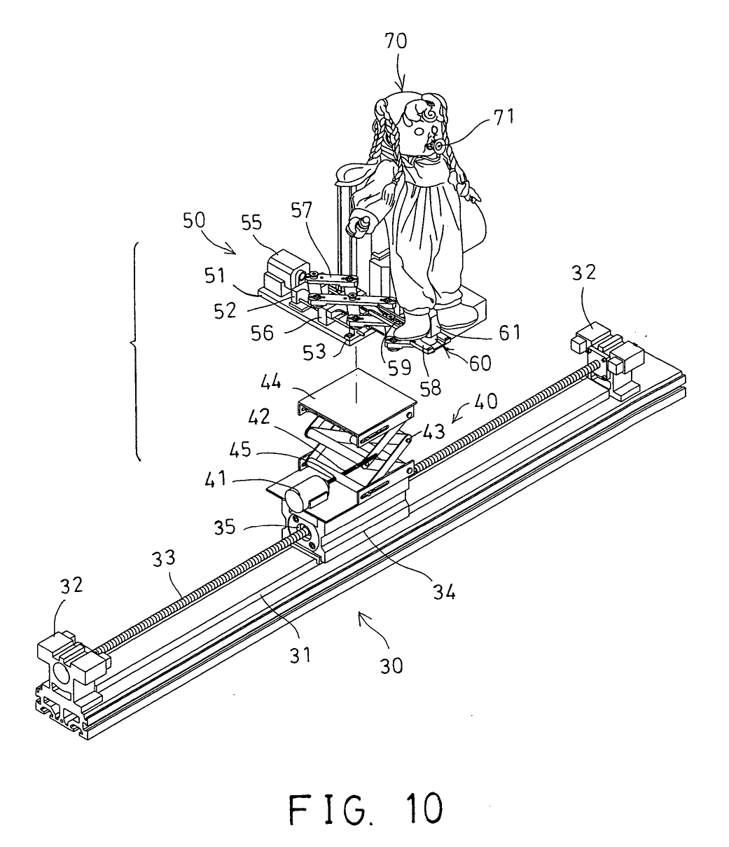

As shown in FIGS. 2-4, and 10-12, the vending machine 1 further includes a fetching device 70 movably disposed within the outer receptacle 10, and movable laterally along an X-axis (FIG. 2) by a lateral moving device 30, and movable upwardly and downwardly along a Z-axis by a vertical moving device 40, and movable forwardly and rearwardly along a Y-axis by a horizontal moving device 50, and rotatably supported by a rotating device 60 which may rotate the fetching device 70 around the Z-axis.

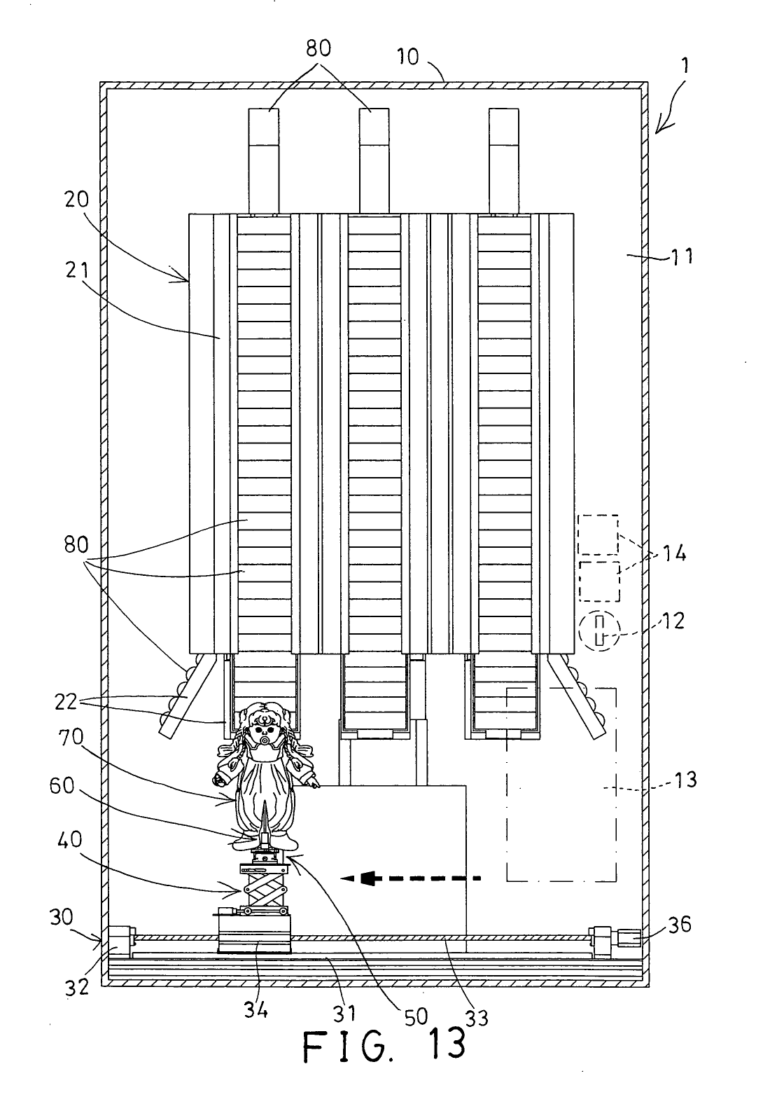

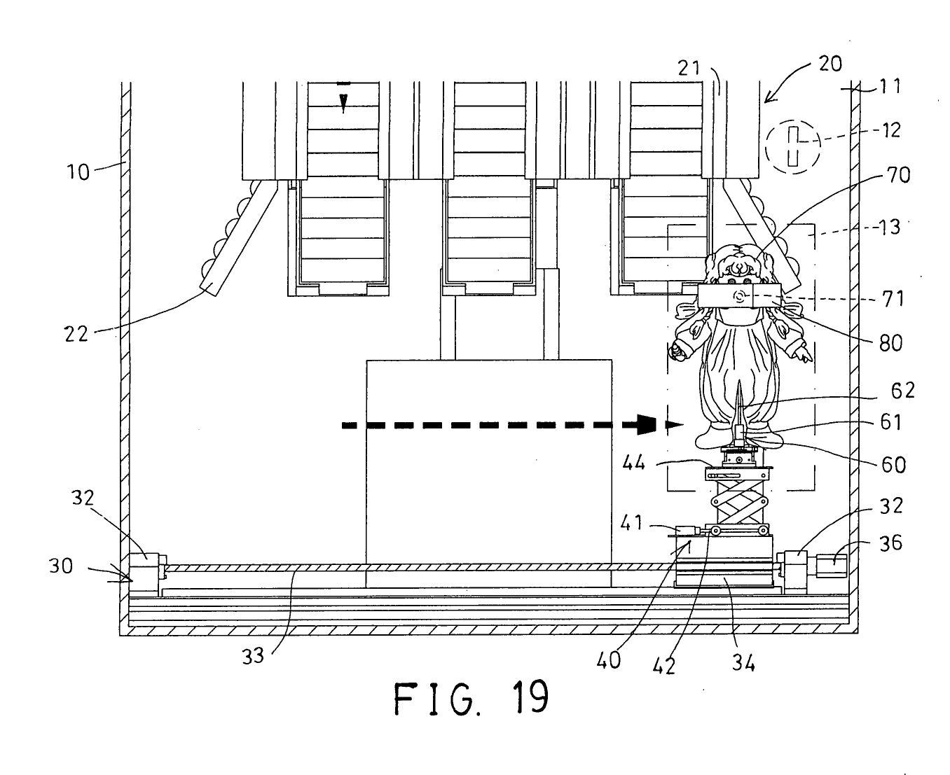

As best shown in FIGS. 2, 3, and 10, the lateral moving device 30 includes a rail 31, two stops 32 disposed on the ends of the rail 31, a bolt 33 rotatably supported between the stops 32 and parallel to the rail 31, and a carrier 34 slidably engaged on the rail 31 and having a screw hole 35 formed therein for threading with the bolt 33, and a motor 36 attached to one of the stops 32 and coupled to the bolt 33 for rotating the bolt 33 to move the carrier 34 along the rail 31 (FIGS. 13, 19).

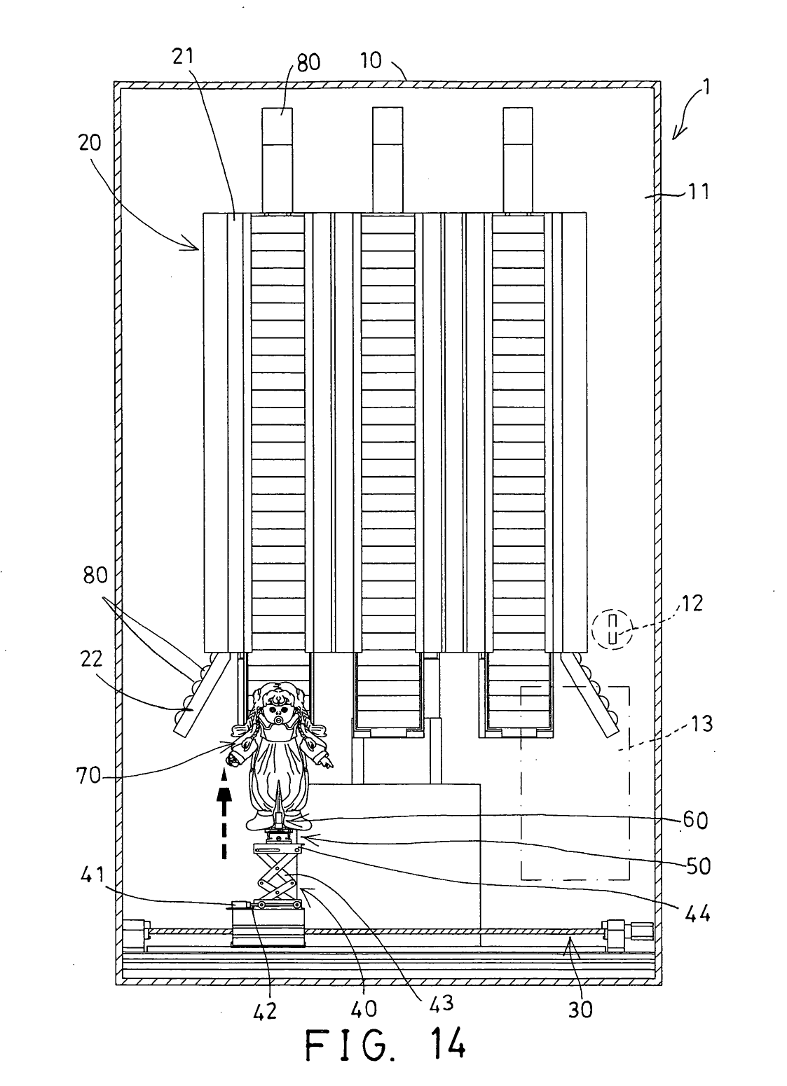

The vertical moving device 40 is provided or disposed on the carrier 34, and includes a motor 41 disposed on the carrier 34, a screw 42 coupled to the motor 41 for being rotated or driven by the motor 41, and a lazy bone device 43 having a table 44 provided on top thereof and having a screw hole 45 formed therein, for threading with the screw 42, which may expand or stretch or retract the lazy bone device 43, in order to move the table 44 up and down relative to the table 44 and the outer receptacle 10 (FIGS. 14 and 17-18).

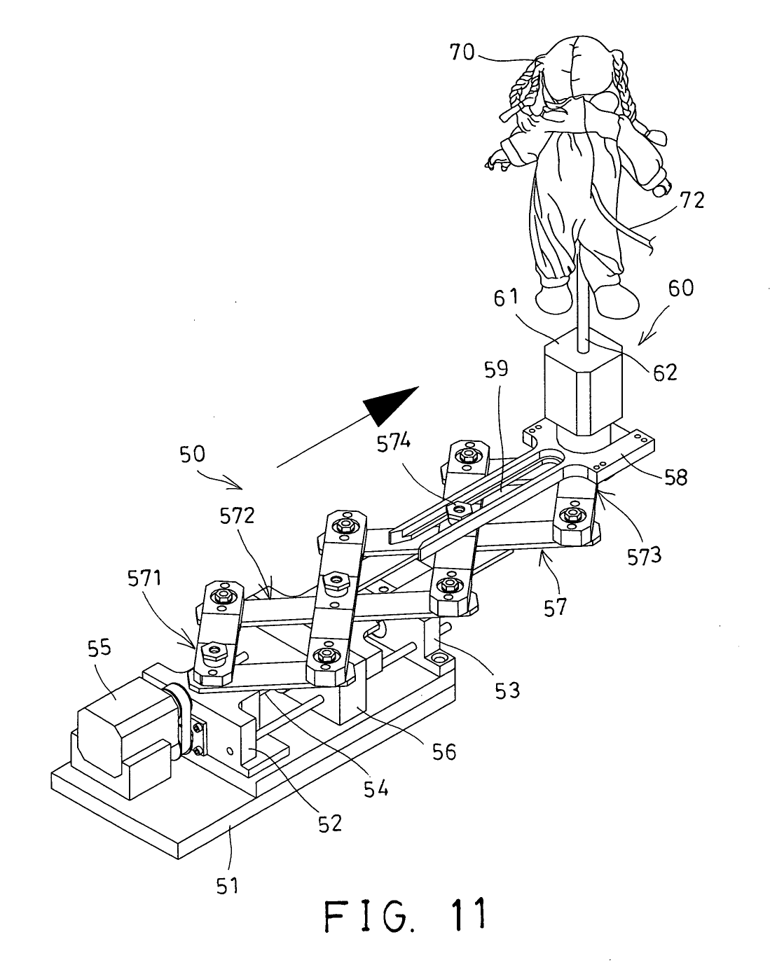

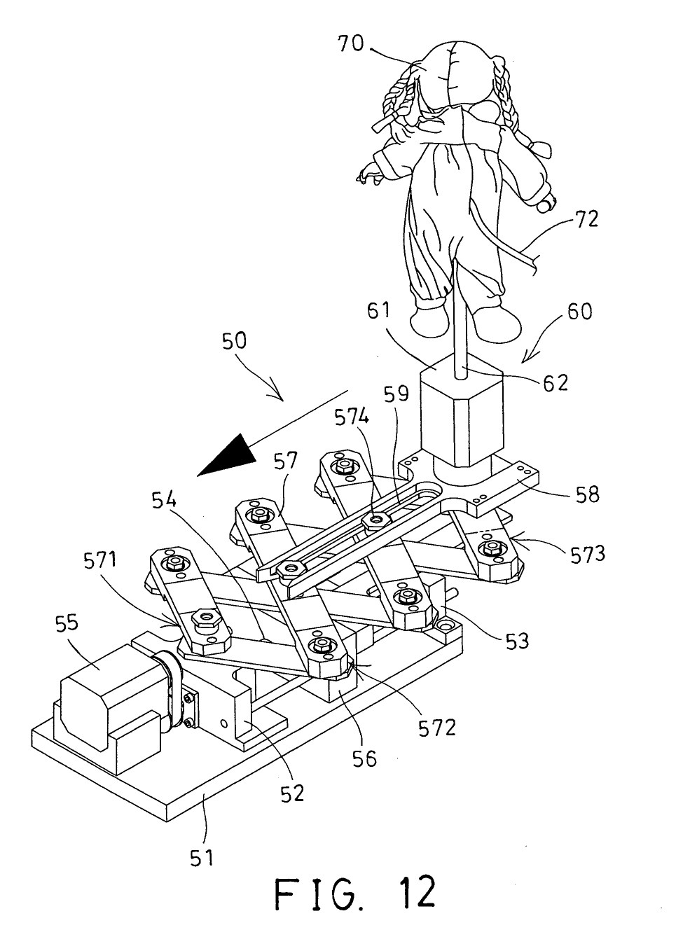

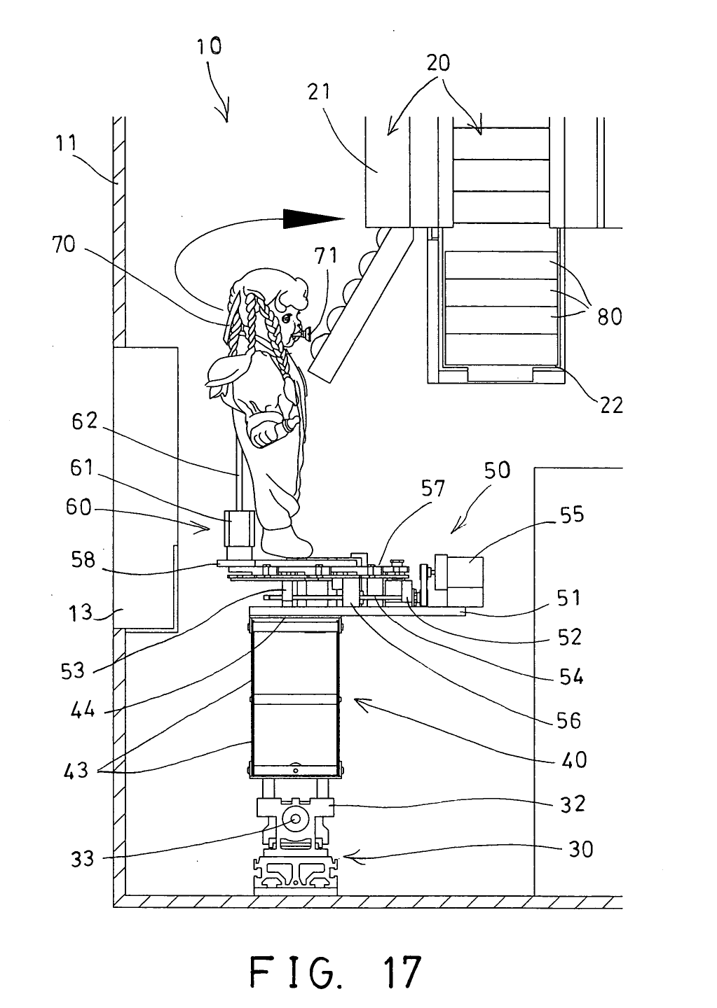

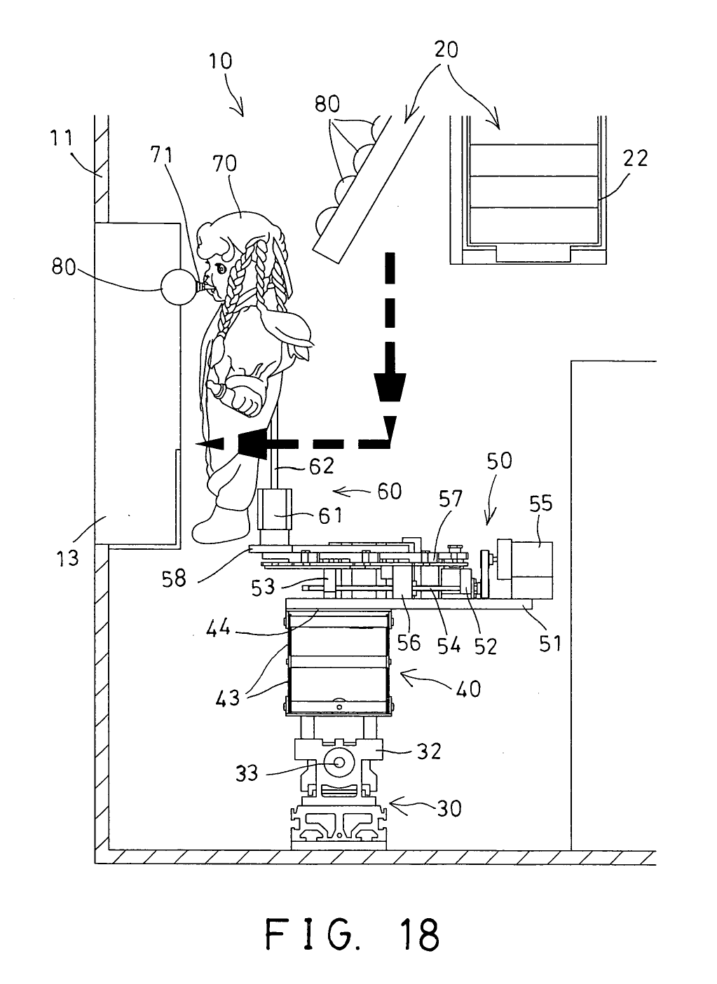

As shown in FIGS. 11-12, the horizontal moving device 50 includes a board 51 disposed on the table 44, two blocks 52, 53 disposed on the board 51, a bolt 54 rotatably supported between the blocks 52, 53, a motor 55 attached to one of the blocks 52 and coupled to the bolt 54 for rotating the bolt 54, a slide 56 slidably disposed between the blocks 52, 53 and threaded with the bolt 54, for allowing the slide 56 to be moved along the bolt 54 by the motor 55 (FIGS. 17, 18).

The horizontal moving device 50 further includes a lazy bone device 57 having one end 571 coupled to one of the blocks 52 and a middle portion 572 coupled to the slide 56, and arranged for being expanded or stretched or retracted by the slide 56 when the slide 56 is moved along the bolt 54 by the motor 55. A guide member 58 is attached to the other end 573 of the lazy bone device 57, and includes a groove 59 formed therein for slidably receiving one or more pins 574 of the lazy bone device 57 (FIGS. 11, 12), and for guiding the guide member 58 and the lazy bone device 57 to move forwardly and rearwardly along the Y-axis (FIGS. 17, 18).

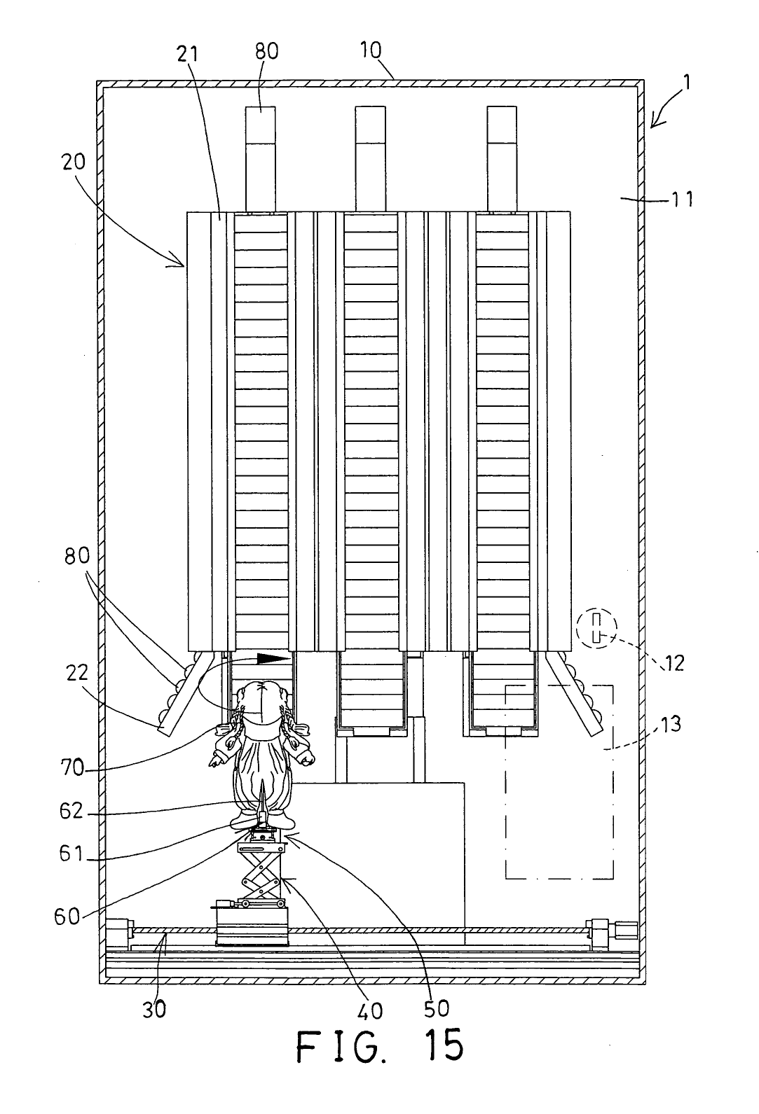

The rotating device 60 includes a motor 61 disposed on the guide member 58 and having a spindle 62 extended upwardly therefrom, for attaching and supporting the fetching device 70 thereon, and for rotating the fetching device 70 relative to the outer receptacle 10 and the magazines 20 (FIGS. 15, 17). The fetching device 70 may be formed or shaped into various kinds of shapes, such as the doll-shaped structure as shown in the drawings, but may also be formed or shaped into the other kinds of shapes, when required.

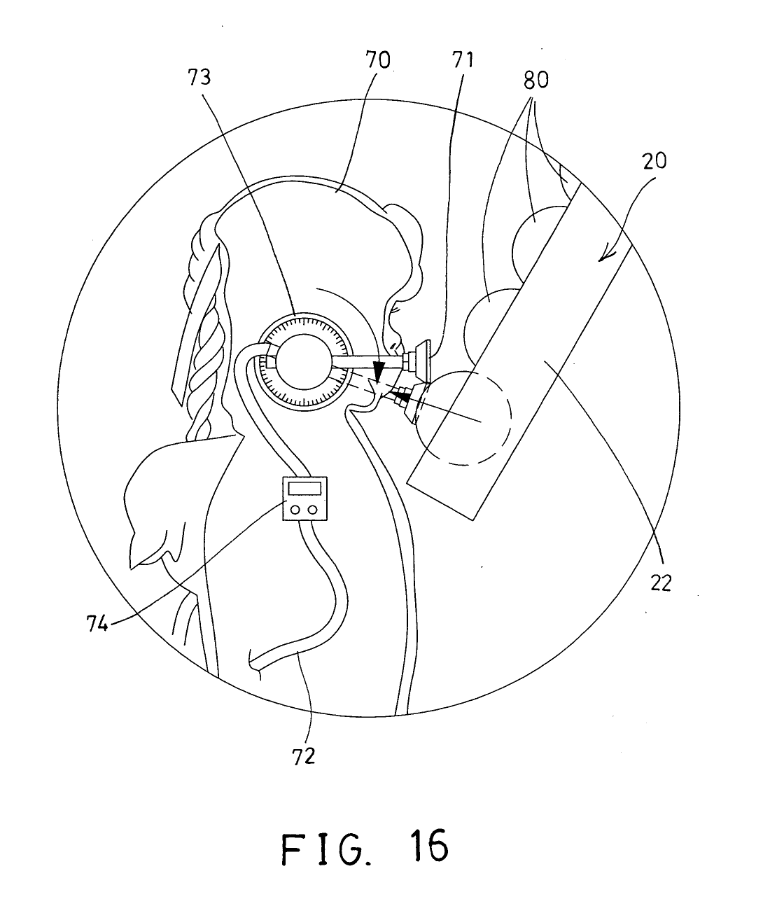

As shown in FIGS. 16-19, the fetching device 70 includes a sucker or vacuuming member 71 for engaging with and for moving the goods 80 from the magazines 20 toward the outlet port or delivery chute 13 of the outer receptacle 10, and a hose 72 coupled to the vacuuming member 71, for coupling to a vacuum source, in order to suck or to draw the goods 80 to the vacuuming member 71. A rotating element 73 (FIG. 16) may be coupled to the hose 72, for suitably rotating and directing the vacuuming member 71 toward the goods 80, and thus for allowing the goods 80 to be suitably drawn to the vacuuming member 71.

The fetching device 70 may further include a control device or a pressure detector 74 (FIG. 16) which may be coupled to the hose 72, in order to detect the pressure within the hose 72, and/or to control or to determine the time when to attract or to draw the goods 80 with the vacuuming member 71, or when to carry and to release the goods 80 toward the outlet port or delivery chute 13 of the outer receptacle 10, to allow the users to easily fetch the goods 80 via the outlet port or delivery chute 13 of the outer receptacle 10.

In operation, when a proper coin or proper coins or paper money or the like are deposited into the coin chutes 12, and when the predetermined goods 80, 83, 88 have been selected with such as the buttons 14, as shown in FIG. 5, the frame 2 and the magazines 20 may be rotated relative to the outer receptacle 10 by the motor 16, until the selected goods 80 or magazines 20 are located forwardly relative to the outer receptacle 10, or are located or directed toward or closer to the fetching device 70.

As shown in FIGS. 13-19, the fetching device 70 may then be moved laterally along the X-axis or along the rail 31 by the lateral moving device 30 (FIG. 13), and/or moved upwardly and downwardly along the Z-axis by the vertical moving device 40 (FIG. 14), and/or moved forwardly and rearwardly along the Y-axis by the horizontal moving device 50 (FIGS. 17, 18), and/or rotated around the Z-axis by the rotating device 60, for suitably directing the vacuuming member 71 toward and to fetch the selected goods 80. The prior vending machines failed to provide a fetching device 70 movable and rotatable and actuatable to fetch and to deliver the selected goods 80, 83, 88 to the delivery chute 13 of the outer receptacle 10.

Accordingly, the vending machine in accordance with the present invention includes a movable and rotatable fetching device for fetching and delivering the selected goods to the delivery chute, and for allowing the users to watch and to see how the selected goods are selected and dropped into the delivery chutes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vending machine comprising:
a receptacle including a delivery chute,
at least one magazine disposed in said receptacle for receiving goods to be sold,
a fetching device, and
means for actuating said fetching device to fetch the selected goods from said at least one magazine, and to deliver the goods toward said delivery chute of said receptacle, for allowing users to obtain the goods via said delivery chute of said receptacle.

2. The vending machine as claimed in claim 1, wherein said receptacle includes a frame disposed therein, to support said at least one magazine on said frame.

3. The vending machine as claimed in claim 2, wherein said receptacle includes a motor disposed therein and having a spindle coupled to said frame, for rotating said frame relative to said receptacle.

4. The vending machine as claimed in claim 2, wherein said frame includes a plurality of slots formed therein, and said at least one magazine includes two flaps selectively engaged in said slots of said frame.

5. The vending machine as claimed in claim 1, wherein said actuating means includes a motor having a spindle attached to said fetching device, for rotating said fetching device relative to said receptacle and said at least one magazine.

6. The vending machine as claimed in claim 5, wherein said actuating means includes a horizontal moving device having said motor and said fetching device disposed thereon, for moving said motor and said fetching device forwardly and rearwardly relative to said receptacle and said at least one magazine.

7. The vending machine as claimed in claim 6, wherein said horizontal moving device includes a lazy bone device having said motor and said fetching device disposed on one end thereof, and expandable for moving said motor and said fetching device forwardly and rearwardly relative to said receptacle and said at least one magazine.

8. The vending machine as claimed in claim 7, wherein said horizontal moving device includes a block, a bolt rotatably attached to said block, a slide threaded with said bolt and coupled to said lazy bone device, and a motor attached to said block and coupled to said bolt, for rotating said bolt to move said slide along said bolt by said motor.

9. The vending machine as claimed in claim 7, wherein said lazy bone device includes at least one pin extended therefrom, a guide member attached thereto and having a groove formed therein for slidably receiving said at least one pin, and for guiding said guide member and said lazy bone device to move forwardly and rearwardly relative to said receptacle and said at least one magazine.

10. The vending machine as claimed in claim 6, wherein said actuating means includes a vertical moving device having said horizontal moving device disposed thereon, for moving said horizontal moving device and said fetching device up and down relative to said receptacle and said at least one magazine.

11. The vending machine as claimed in claim 10, wherein said vertical moving device includes a lazy bone device having a table provided on top thereof for supporting said horizontal moving device thereon, a screw coupled to a motor and threaded with said lazy bone device, to selectively expand and retract said lazy bone device.

12. The vending machine as claimed in claim 10, wherein said actuating means includes a lateral moving device having a carrier to support said vertical moving device thereon.

13. The vending machine as claimed in claim 12, wherein said lateral moving device includes a bolt rotatably supported between two stops, said carrier includes a screw hole formed therein for threading with said bolt, and a motor attached to one of said stops and coupled to said bolt, for rotating said bolt to move said carrier along said bolt.

14. The vending machine as claimed in claim 13, wherein said lateral moving device includes a rail, said stops are attached on said rail, and said carrier is slidably engaged on said rail.

15. The vending machine as claimed in claim 1, wherein said fetching device includes a vacuuming member coupled to a vacuum source, for engaging with and for moving the goods from said at least one magazine toward said delivery chute of said receptacle.

16. The vending machine as claimed in claim 15, wherein said fetching device includes a hose coupled to said vacuuming member, and a rotating element coupled to said hose, for rotating and directing said vacuuming member toward the goods.
